(19) United States
(12) Patent Application Publication
(10) Pub. No.: US 2020/0043026 A1
(43) Pub. Date: Feb. 6, 2020

(54) DECISION SUPPORT SYSTEM AND METHODS ASSOCIATED WITH SAME

(71) Applicant: WhiteHawk CEC Inc., Alexandria, VA (US)

(72) Inventor: Luis J. CRUZ-RIVERA, Alexandria, VA (US)

(21) Appl. No.: 16/484,703

(22) PCT Filed: Feb. 8, 2018
(86) PCT No.: PCT/US2018/017466

§ 371 Date: Aug. 8, 2019

Related U.S. Application Data
(60) Provisional application No. 62/456,338, filed on Feb. 8, 2017.

(51) Int. Cl. G06Q 30/02; G06N 5/04; G06Q 10/06

(52) U.S. Cl. CPC G06Q 30/0203; G06Q 10/06315; G06N 5/04

(57) ABSTRACT

Methods and systems for optimizing a match between a customer prioritization and one or more products including defining criteria, capturing traditional criteria and capturing additional criteria related to the one or more products, establishing customer prioritization based on at least two question-and-answer pairs gathered from the customer and determining the prioritization by: generating at least one question related to the customer's organization, capturing the answer to the at least one question to form a first question-and-answer pair, selecting a specific customer profile having the highest affinity with the first question-and-answer pair, choosing a second question based on the specific customer profile and evaluating at least the first question-and-answer pair and second-and-answer pair to establish at least one customer prioritization based on the evaluation, mapping the criteria against at least one customer prioritization, and outputting at least one matched product based on the mapped criteria and at least one customer prioritization.

### CROSS-REFERENCE TO RELATED APPLICATIONS

This application claims priority to U.S. Provisional Application No. 62456338, filed Feb. 8, 2017, the contents of which is incorporated in its entirety herein by reference.

### TECHNICAL FIELD

This invention relates generally to decision-support systems and, in particular, to the field of computer aided decision for multi-objective queries using a combination of adaptive reasoning, cognitive causal models, and text processing for knowledge driven decision support.

### BACKGROUND

In complex situations, finding optimal solution sets is often threatened by information overload and the requirement of deep knowledge within the problem area. This can be addressed by distributed cognition—the use of highly trained individuals with access to substantial amounts of relevant information. However, most applications for dynamic domains, where variable multifactor analysis rather than a static progressive stepwise approach is appropriate, require effective information gathering, information fusion, sense-making, and information delivering to develop effective solutions, while reducing the threats from information overload and distributed cognition to an acceptable level.

Current solutions are insufficient to optimize the matching between the ideal product and customer's needs. On one hand, product specifications and the products applicability for specific scenarios are traditionally done based solely on product information provided by the vendor of the product. While this information can be helpful in some circumstances, there is no optimization of the matching of the product to a customer specific needs except by highly trained consultants. In addition, customer needs can vary substantially depending on the size of organization, the type of industry that the organization is in, the associated regulatory or other requirements for that industry, the sophistication and resources of the organization, and other factors.

This non-optimize matching is illustrated in FIG. 1. As shown in FIG. 1, customer input 101 and product input 103 is driven through some sort of decision process 105, where the decision process is typically guided with substantial human interaction. However, output of the decision 105 may simply associate one product with an incomplete or incorrect assessment of the customer's needs, resulting in a non-optimize match, as shown in customer product match 107.

Take the domain of cyber-security as an example, the cognitive demands in said domain are complex, dynamic, and time sensitive. Entities have unique and complex challenges based on their business objectives, threat profile, and existing technology. The dynamic threat and solution space can make it difficult for entities to review the large volume and technically dense sources of information and determine a relevant path forward to their business objectives which can significantly hamper the quality and the timeliness of decision-making related to cyber security approaches and investment which can have possibly catastrophic consequences. This is compounded by the fact that entity's expertise can be distributed across the entity and have differing levels of access to various information sources, due to constraints such as security concerns.

As such, there is a need for improved methods and apparatuses to match optimize product selection with a customer's needs based on more complete understanding of the customer's actual needs than are currently available.

### SUMMARY

This application is directed to a method for optimizing a match between a customer prioritization and one or more products, the method including defining criteria that characterizes the one or more products including capturing traditional criteria related to the one or more products, and capturing additional criteria related to the one or more products, establishing customer prioritizations based on at least two question-and-answer pairs gathered from the customer and determining the prioritization by: generating at least one question related to the customer's organization, capturing the answer to the at least one question to form a first question-and-answer pair, comparing the first question-and-answer pair to stored question-and-answer pairs, the stored question-and-answer pairs being associated with customer profiles, selecting a specific customer profile having the highest affinity with the first question-and-answer pair, choosing a second question based on the specific customer profile, providing the second question to the customer, capturing the second answer and forming a second question-and-answer pair, and evaluating at least the first question-and-answer pair and second-and-answer pair to establish at least one customer prioritization based on the evaluation, mapping the criteria against at least one customer prioritization, and outputting at least one matched product based on the mapped criteria and at least one customer prioritization.

This application is also directed to a method of improving customer survey responses, the method including generating at least one question related to a customer organization, capturing the answer to the at least one question to form a question-and-answer pair, comparing the question-and-answer pair to stored question-and-answer pairs, the stored question-and-answer pairs being associated with a plurality of specific customer profiles, identifying a specific customer profile from the plurality of specific customer profiles based on the comparison, and choosing a second question based on the specific customer profile.

This application is also directed to a method of optimizing product selection by a customer, the method comprising capturing traditional criteria associated with the product, capturing additional criteria associate with the product, forming a matrix including product characteristics associated with the traditional and additional criteria, and processing the matrix based on at least one characteristic identified by the customer as relevant.

This application is also directed to a computer system capable of executing the methods above.

This application is also directed to a computer readable medium containing program instructions for causing a computer to perform the methods described above and herein.

### BRIEF DESCRIPTION OF THE DRAWINGS

The following listing includes a description of the figures that accompany this application.

FIG. 1 is an illustration of current decision-support systems.

FIG. 2 illustrates an exemplary embodiment of the system and methods described herein.

FIG. 3 is an exemplary output of the system using the methods described herein.

FIG. 4A illustrates in more detail a portion of the exemplary embodiment of the system and methods described herein.

FIGS. 4B and 4C illustrate exemplary question-and-answer pairs used in conjunction with the exemplary embodiments of the system and methods described herein.

FIG. 4D illustrates in more detail a portion of the exemplary embodiment of the system and methods described herein.

FIG. 5 illustrates in more detail a portion of the exemplary embodiment of the system and methods described herein.

FIGS. 6A and 6B illustrate exemplary methods of gathering survey data consistent with the embodiments described herein.

FIG. 7 illustrates in more detail a portion of the exemplary embodiment of the system and methods described herein.

FIGS. 8A and 8B illustrate in more detail portions of alternative embodiments consistent with the embodiments described herein.

FIG. 9 is an exemplary embodiment of the overall system and methods described herein.

FIG. 10 illustrates in more detail a portion of the exemplary embodiment of the system and methods described herein.

FIG. 11 illustrates in more detail a portion of the exemplary embodiment of the system and methods described herein.

FIG. 12 illustrates in more detail a portion of the exemplary embodiment of the system and methods described herein.

FIG. 13 illustrates in more detail a portion of the exemplary embodiment of the system and methods described herein.

FIG. 14 illustrates an exemplary embodiment of a product feature matrix consistent with the embodiments described herein.

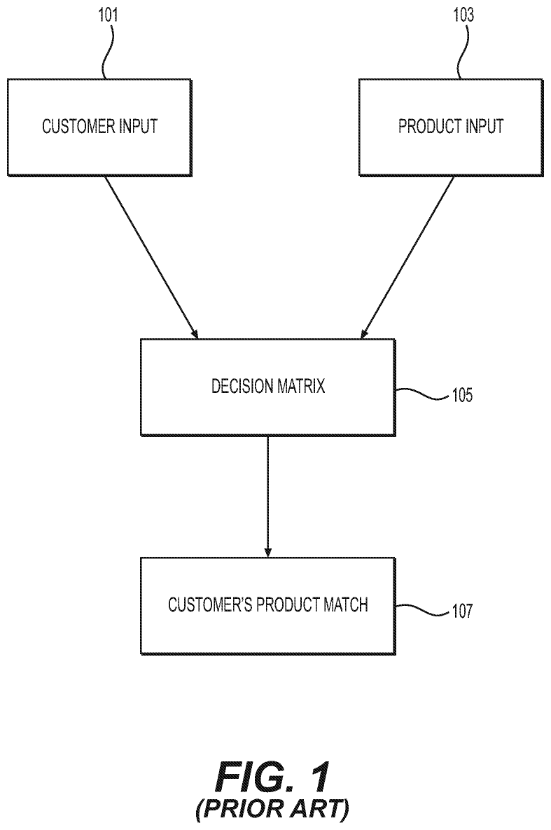

### DETAILED DESCRIPTION

The system and method for decision support use a combination of adaptive reasoning and cognitive causal models. This exemplary embodiments of the invention described below more specifically relates to the field of multiple factor decision-making methods and systems that are applicable to a variety of decision-making contexts and adaptive reasoning applications such as, but not limited to, cyber investment, crisis planning, and supply chain assurance decisions.

In particular, aspects of the invention that aid an agent in decision-making include, but are not limited to: managing all the sub-decisions, educating the user, highlighting the most important sub-decisions, distinguishing significant differences between solutions, supplying various evaluation tools, preventing blind spots, assisting the agents with supporting information in the decision process, and learning about the agents from the decision process. As used herein, an agent may be a software module or combination of software modules that operate to assist in decision making in a manner consistent with the embodiments described herein. An agent may be referred to as an agent device in the alternative herein.

Another general object of the invention is to enable solution selection in a non-tactile purchasing environment such as, but not limited to, those encountered in e-commerce, or web-based, or on-line sales transactions.

As used herein, a computer system may include computer systems with one or more processors and one or more memories, coupled to the one or more processors on the premises or in a virtual environment or hybrid configuration, performing one or more of the operations described herein. Alternatively, or in combination, the computer system may include one or more part of an embodiment described herein that is provided on a virtual system, such as a cloud.

An additional general object of the invention is to provide methods and a system that compensates for common human cognitive problems that occur in decision-making.

As used herein, “customer” refers to the end consumer of the decision support systems and methods described herein. The customer may be alternatively referred to as a “user” herein. The decision support systems and method described herein interact with one or more “vendor” to gather data on products sold by the vendor and data related to the vendor. A “client” is a party that is a beneficiary of the customer. For example, a customer may supply different types of services to a client and the client's needs may be relevant the types of products that are acceptable for a customer. In other words, the optimize solution for a customer may be driven, in part, or in whole, by the needs of the clients that that the customer serves.

As used herein, a unit may include a computer system, a portion of a computer system, or may be a software module.

As used herein, a node is associated with a specific customer criteria and relates to a trait or characteristic of the customer's organization and its needs. One or a series of more than one question is associated with each node as described in greater detail below.

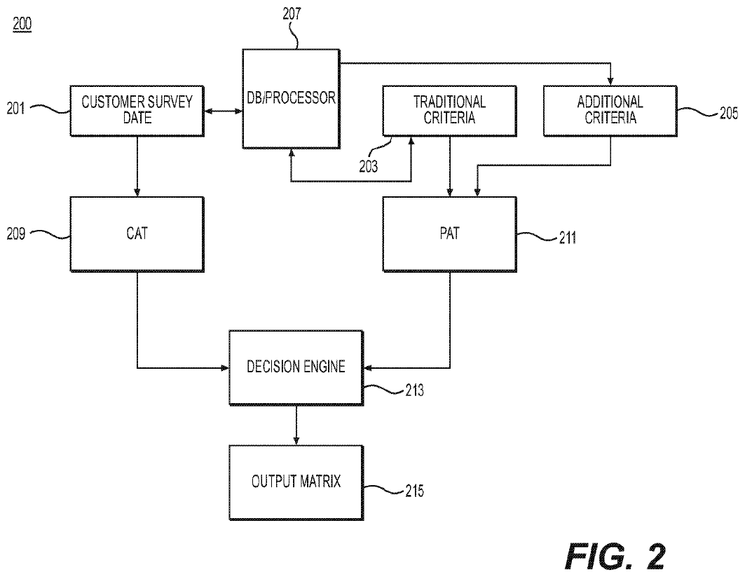

FIG. 2 provides an overview of the system and associated method that allows for optimize matching of customer needs with the product appropriate for the customer. System 200 accepts as inputs customer survey data 201, as well as traditional criteria 203 and additional criteria 205.

Customer survey data 201 is a list of criteria that help define the needs of the organization (which may be a customer or user) based on predetermined factors. Customer survey data 201 may relate to cost criteria. In this or another embodiment, customer survey data 201 may relate to the ease of installation of a specific product. In this or another embodiment, customer survey data 201 may relate to ease of maintenance for customer for a specific product. In this or another embodiment, customer survey data 201 may relate to hardware resource requirements for a user. Hardware resource requirements may themselves also relate to the ease of maintenance, monetary costs associated with specific hardware, specific needs for customer driven by the industry, or needs dictated by the client service by the customer seeking the optimize product matching. In this or another embodiment, customer survey data 201 may also relate to the completeness of the security coverage provided by product. As used herein, completeness relates to the coverage of physical and virtualized systems in an overall system. For example, if a system includes both a physical server coupled to an analytic tool hosted on a virtualized cloud subsystem, the completeness of a product that provides cybersecurity to both the physical server and the cloud based subsystem is more complete than a product that only provides security for the physical server. Customer survey data 201 may also include responses that identify current customer security systems and software.

In this or another embodiment, other questions may be helpful in developing a complete profile of the customer and thus the customer's needs.

In this or another embodiment, a question may relate to the industry of the customer. Questions related to a specific industry can provide additional details on the focus of the customer's business. As a non-limiting example, an industry such as “finance” may be associated with dynamically derived or predetermined keywords such as bank, banking, capital, capitalization, commodity, commodities, economics, financial, financial instrument, Financial Services ISAC, FS-ISAC, funds, insurance, investment, investment manager, liquidity, market, private equity fund, SEC, Securities & Exchange Commission, stock, or venture capital. Questions related to a specific industry may also provide additional details on regulatory requirements that specific industries much follow. It will now be apparent that relevant regulations for specific industries may be stored or accessible to the system in order to ensure compliance with such regulations. It will now also be apparent that the system may periodically and automatically check for such updates to regulation. It will also be apparent that the system may be configured to evaluated proposed changes to a relevant industry regulation and provide alternative options to the user based on such possible changes to regulations. In another non-limiting example, when a company is involved in the healthcare space, it is typically subject to higher data privacy requirements. Thus, customers seeking an optimize software product for this specific type of industry may require higher levels of security be built into the product than in other industries in order to ensure the privacy of their client and to comply with regulations.

Evaluation of a customer's needs may be inferred from criteria such as the scale of the customer. Scale may include a number of factors. For example, the scale of the customer's organization may be ascertained by evaluating the reported numbers of computers, employees, locations, and users for a specific customer. With such information, an output representing the overall size and complexity of the customer may be assigned a value associated with similar profiles of other customers.

As a non-limiting example, variables such as C, E, L, and U may be assigned to represent the number of computers the customer owns, the number of employees the customer has, the number of locations the customer operates a business at, and the number of computer users that the customer has, respectively. It will now be clear one of ordinary skill in the art, that in assigning such variables the number of employees and the number of users will not necessarily be the same. For example, some employees do not require computer access to complete their employment at the customer's organization. Alternatively, the customer may have employees that include part-time or temporary employees that may or may not constitute users.

After receiving a customer's feedback on the above described variables through a series of questions, these variables may be fed into a formula that includes weighting factors and results in a number associated with different scales of all available potential customers. For example, a formula such as that shown below:

S=W_{CC}C²+W_{CE}CE+W_{CU}CU+W_{EL}EL+W_{LL}L²

may be computed. In the above formula, constant parameters W_{CC}, W_{CE}, W_{CU}, W_{EL}, and W_{LL} may be used to create assign a score for the scale of the customer. In particular, W_{CC}, W_{CE}, W_{CU}, W_{EL}, and W_{LL} may represent scaling factors associated with the complexity and risk associated with computer interactions, with computer employee interactions, with computer user interactions, with securing and vetting employees across multiple locations, and with the communication shipment between multiple corporate locations, respectively. The output, S, then provides an indication of scale. Breakpoints for categorizing the scale the customer may be set, for example, using empirically derived data. The breakpoints may be set, for example, at a “small” scale customer when S is less than 3800, a “medium” scale customer when S is greater than or equal to 3800 and less than or equal 22,000, and a “large” scale customer when S succeeds 22,000. It will now be apparent to one of ordinary skill in the art, that the S factor association with different scale customers, the weight provided any constant parameter, the number breakpoints, and the scale factors associated with the breakpoints may be configured based on specific system requirements. This configuration may be based on empirical data sets that inform the relative scale of a specific business as compared to the larger set of businesses captured in the empirical data sets. Alternatively, or in conjunction with the empirical data sets, the configuration of the variables, the constant parameters, and the formula used to calculate scale, may be varied based on specific system requirements.

Data associated with the above variables may be gathered through a series of questions. For example, the number of employees, the number of users, the number of locations, and the number of computers associated with a customer's organization made be derived through questions posed to the user.

Cyber maturity is another criteria that may be relevant to establishing the customer's needs. Cyber maturity focuses on the development and the robustness of the customer's information technology infrastructure and security.

As a non-limiting example, variables including C, ε, T, and U, respectively, the primary form of customer interaction with their clients, the number of dedicated information technology security staff, the amount of traffic to a customer's website or through their computer network, and the number of dedicated information technology support bstaff, may gathered by user interaction. For example, these variables may be assign values based on responses customer survey questions. The variable C may be assigned values to correspond to a mapping of interactions to values is: “face-to-face”: 0.3, “phone”: 0.7, “website”: 1.0, “remote”: 1.3, “mobile”: 1.7, and “email”: 2.0. ε may be set to the number of full time equivalent information technology security staff and U may be set to the total number of all full time equivalent information technology staff. T may be assigned a value consistent with traffic on the customers site or business, e.g., “low traffic ” sets T=25, “medium traffic” sets T=158, and “high traffic” sets T=1000.

After receiving the customer's feedback, these variables may be used to develop an assessment cyber maturity of the customer. For example, additional parameters including a minimum number of information technology security personal and the total security headcount, represented as ε₀ and ε_{T}, respectively, may be used to evaluate the effectiveness of security staff. For example, the cyber maturity of the customer's organization may be calculated be using the following formulas:

$${ɛ}_{T} = ɛ + \frac{U}{{U}_{ɛ}}$$

$${ɛ}^{′} = \{ \begin{matrix}{ɛ}_{T} , & if {ɛ}_{T} > {ɛ}_{0} \\ \frac{{ɛ}_{T}^{2}}{{ɛ}_{0}} , & otherwise\end{matrix} \\ M = \frac{{CE}^{′} V}{T}$$

where ε′ represents the effective number of security staff, including the discount & scaling due to minimum number of security staff, and M is representative cyber maturity of the customer's organization, e.g., a score. With M calculated, breakpoints for cyber maturity may be set similar to those described above with respect to scale. For example, a low cyber maturity may be associated with an M score less than 0.0023, medium cyber maturity may be associated with an M score between 0.0023 and 0.061, and a high cyber maturity score may be a score greater than 0.061. It will now be obvious to one of ordinary skill in the art that the above described cyber maturity variables are exemplary and that other variables may be incorporated into the calculation to derive the cyber maturity score M.

Corporation maturity may also be relevant towards classifying a customer and may be derived through a series of questions. Data associated with the customer's corporation maturity variables may be derived from a series of questions. These may be the same questions posed to determine the scale of the organization including the number of employees, the number of users, the number of locations, and the number of computers. Alternatively, or in combination, the number of employees divided by the number of users, the number of locations divided by the number of computers, the number of employees divided by the number of computers, the number of network segments divided by the number of locations, the number of employees weighted by an average turnover, or the amount of web traffic may be calculated as variables associated with the corporate maturity of an organization. It will now be apparent to one of ordinary skill in the art that the responses to questions such as those above may be categorized and associated with variables that allow calculation of a single score or metric that is representative of the customer organization's corporate maturity similarly to those described above with respect to the scale and cyber maturity scores discussed above

Cyber intelligence maturity is another criteria that may be evaluated through customer interaction, e.g., the customer survey. Questions focused on security knowledge and posture may be posed to a customer to determine such a value. For example, the motivation of the customer with respect to the acquiring of a new product may be relevant. Such questions may include questions directed towards the customer's proactive research and planning, the customer's response to legal or formal external requirements, the response to a recent attack by the customer, the response of the customer to a recent attack on another in the customer's industry, the customer's response to a recent attack on others outside of the user's industry, and the customer's response to warnings obtained from pen tests or other vulnerability assessments. Other questions may involve assessing the customer's response to past problems, including denial of service attacks, insider attacks, infectious malware, ransomware attacks, phishing, man in the middle attacks, and computer or hardware failure issues. Other questions may also assess the customer's cyber intelligence maturity by gaining an understanding of the customer's ability to handle ongoing challenges. Such challenges may include different factors including lack of visibility into network traffic, reliance on outdated hardware and software systems, an indication of existing systems are insufficient for the demands of the system, e.g., high integrity and traceable data, and other factors. It will now be apparent to one of ordinary skill in the art that the responses to questions such as those above may be categorized and associated with variables that allow calculation of a single score or metric that is representative of the organizations cyber intelligence maturity similarly to the scores discussed above.

In this or another embodiment, the amount of remote or mobile workers that in the customer's organization may also be captured. Such data may be relevant, for example, to the types of features and level of security required by the customer. The amount of virtualization, i.e. the type and scope of cloud-based processes relevant to the customer's business, may also be a relevant factor. In this or another embodiment, customer survey data 201 may include data security priorities including the business value or business risk and which sorts of data compromise are most likely to be damaging to them. In this or another embodiment, customer survey data 201 may include specific security risks that are a priority for a customer. Such security risks may include staff turnover, compliance issues related to a specific industry or customer needs, physical security, network security, requirements for data integrity, and the handling of sensitive information, such as financial data, if particularly relevant to a customer's business. In this or another embodiment, customer survey data 201 may also include the requirements that third parties, e.g., clients or others associated with the customer's business such as vendors, have access to the customer's systems and applications. In this or another embodiment, specific sensitive client data may also be identified as part of the customer survey data 201. Such sensitive data may also include personally identifying information such as a client's name, address, birthday, social security number, or other identifying information. Other sensitive data may include credit card numbers or other information related to financial transactions, such as bank account information. Other sensitive data may include health data including medical records or other client specific information.

Customer survey data 201 may also include other questions that helps define latent security risks for a customer. In this or another embodiment, such concerns may include, whether or not the organization conducts employee background checks, whether the customer use seasonal or temporary workers, what level of access granted to seasonal or temporary workers, and other customer specific situations.

Customer survey data 201 may also include additional information related to planning by or experience of a customer. Such additional information may include corrective research and planning by the customer in the event of data breach or data loss. Additional information may also include responses to recent attacks by the customer. Additional information may relate to a response to a recent attack against others in the customer's industry. Additional information may also include vulnerability assessments and the results thereof previously provided to the client. Additional information also includes past problems experienced by the customer. Such problems may include, but are not limited to, denial of service attacks, insider attacks, infectious malware being present in the customers' systems, fishing incidents, man in the middle attacks, or data loss.

Customer survey data 201 may also include additional information to further optimize the selection of a product by customer. Such information may be gathered through a series of interview questions. For example, in this embodiment or another, a series of questions may be presented based on the trigger question. An exemplary trigger question is the size of the office, e.g. a small office having one location with fewer than 10 employees. In contrast, if the answer to the trigger question is a larger corporation, this may drive an alternative set of questions based on a presumed level sophistication and resources consistent with larger organizations.

Another trigger question may involve the current staffing of information technology (IT) professionals at the customer's organization (either in-house personnel or via outsourcing). Such a trigger question may prompt additional questions that help provide a rating of the likely effectiveness of the IT personnel. For example, the customer may have a “low” level of support by IT professionals if the staff is focused on pageant configuration management. A “higher” level of support by IT professionals may be indicated by regular meetings and reports, as well as formal methods of tracking issues. An even higher level of support by the IT professionals may be indicated by regular network audits and high levels of reliability for system, as well as IT professionals driving implementation of new products and services that enhance security.

Customer survey data 201 may also include questions related to the rate of employee turnover. Questions related to this act as a proxy for insider risk assessment. It may also contribute to estimates for recurring on-boarding costs (in terms of IT security & support).

Traditional criteria 203 corresponds to criteria associated with the product typically provided by the vendor. Such criteria may include price. Other traditional criteria may include specific features of a specific product. For example, the license type may be relevant to a customer. As an example, the customer may have a preference for a license on a central processing unit (CPU), per user, or a site license basis. Other criteria may include computational load, e.g., the quantity of CPU resources required to operate the product. Another criteria may be whether the product is agent-less or agent-based, which will impact the amount of IT professional staffing to effectively deploy the product. Yet another traditional criteria may be the ability to scale the product over time. Yet another traditional criteria may be the ability of a product to handle multiple user or systems. Yet another traditional criteria may be the ability to deploy the product either on a cloud or traditional network structure. Yet another traditional criteria may be the interoperability of the product with existing or planned system upgrades.

Additional criteria 205 help further define a product that will allow matching of the product in an optimize manner to a customer's needs. Additional criteria 205 includes nontraditional variables that are not systematically analyzed when evaluating the product. Additional criteria 205 may include, for example, reviews of the product from public sources. In this or another embodiment the public source may include a blog related to the product applicability in a specific industry or operating environment. In this or another embodiment, additional criteria 205 may also include information obtained from technical discussion boards or other sources that professionals within the specific industry rely upon. As an example, the information obtained from a technical discussion board could include discussions by system administrators tasked with deploying the specific product and identify issues relevant to optimize matching of a product to a customer's needs. The vendor of the product themselves may provide information that can be evaluated as additional criteria 205. For example, when vendors prepare a white paper related to the products deployment, this can provide additional information related to customer criteria that would help enable and optimize selection of a product.

Sentiment analysis is another example of an additional criteria that may be relevant to the product. Sentiment analysis, as used herein, is a quantification of the reputation associated with public statements related to a specific product. For example, when analyzing a review of the product from a public source, the statements made in the review may be parsed to determine a positive or negative opinion of the product. As a more detailed example, a statement in a review associated with a specific product may state “this product performed well.” In contrast, a review associated with a specific product may instead state that “this product did not perform well.” A positive sentiment score would be associated with the former and a negative sentiment score with the latter. This sentiment score may be, for example, a discrete positive or negative opinion and expressed as a 0 or 1.

This baseline sentiment analysis may be further defined based on the reputation of the source where the product reviews obtained. For example, the discrete positive or negative opinion may be weighed more heavily or less heavily based on associated prestige of the source where the review was obtained. As an example, reputable and recognize journals within a specific industry may be more heavily weighted than a blog or sponsored webpage. In the above described or other embodiments discussed herein, the url associated with a higher reputation journal may be used as an identifier of a higher reputation source and a review more heavily weighted. Alternatively, key word lists associated with positive reputation, e.g., well regarded scholar's names may also be used to identify authorship of a higher reputation publication and higher weight.

It will now be apparent to one of ordinary skill in the art that the scoring and weighting of the score associated with the sentiment analysis may be derived using a formula that produces an output, or score, associated with the specific review of the specific product. It will also now be obvious one of ordinary skill in the art that such a score may be weighted based on a reputational score associated with the publication or website in which the review appears. It will now further be obvious to one of ordinary skill in the art that other means of benchmarking reputational score of the publication or website may be conducted automatically. Alternatively, or in conjunction with the automatic benchmarking, the system operator of the decision support systems and methods described herein, may specifically assign a reputational rank to a specific publication or website. It will also now be obvious one of ordinary skill in the art that sentiment analysis may be conducted automatically, for example, using natural language processing of the publication or webpage where the review is found, in conjunction with, or independent of, the systems and methods described herein.

Additional criteria 205 may be gathered in a variety of ways. For example, a scraper may be used. In this or another embodiment, the scraper may be an automated program that routinely searches the web for additional information. Such additional information may include vendor reports. Such additional information may, alternatively or in addition, include information gathered from industry websites dedicated to providing reviews of products used by those in the industry. Additional criteria 205 may also be gathered by hand selecting relevant documents related to a product. Such documents may be provided to the scraper to extract relevant information. For example, the scraper may include a natural language processing feature that allows relevant information to be extracted based on predefined criteria. Based on the foregoing description, it will now be apparent to one of ordinary skill in the art that other methods of extracting information from paper or electronic sources may be used to gather additional criteria 205 without deviating from the scope of the inventions described herein.

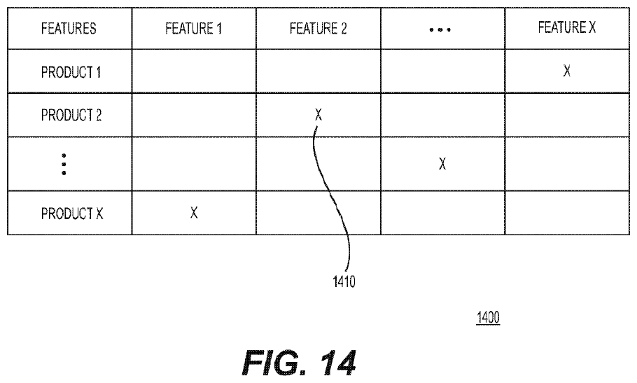

Also based on the foregoing description, it will now be obvious one of ordinary skill in the art that other methods to define the most relevant data the product and the customer may be used. For example, in addition to using the responses of a single customer gathered for customer survey data 201, a database and processor 207 may be used to identify patterns in customer survey data 201, traditional criteria 203, or additional criteria 205 based on earlier gathered customer survey data, traditional criteria, and additional criteria. For example, database and processor 207 may use pattern matching to identify earlier calculated results based on earlier provided customer data and product data. As used herein, customer data means any combination of customer survey data that is provided to and analyzed by the system 200. Product data is any combination of traditional criteria and additional criteria that is provided to and analyzed by the system 200. It will also now be apparent to one of ordinary skill in the art the traditional and adaptive databases, as well as standard or specialized computer processors, may comprise database and processor 207 without the deviating from the spirit of the inventions described herein. Product features may be gathered into a product matrix as illustrated in FIG. 14 and are described in greater detail below.

In the exemplary system 200, customer survey data 201, traditional criteria 203, and additional criteria 205 may be processed by a customer analysis tool (CAT) 209 and a product analysis tool (PAT) 211. For example, customer analysis tools 209 may gather and organize customer survey data 201. In this or another embodiment described below, the customer analysis tool 209 may also receive additional feedback from database and processor 207 that provides additional criteria to assist in developing a customer profile. The product analysis tool 211 may gather and organize product data including traditional criteria 203 and additional criteria 205.

Once the data is gathered and organized by the customer analysis tool 209 and product analysis tool 211, it is provided to a decision engine 213. Decision engine 213 may produce output matrix 215 based on the product data and prioritization of the client derived from customer survey data organized by the customer analysis tool 209.

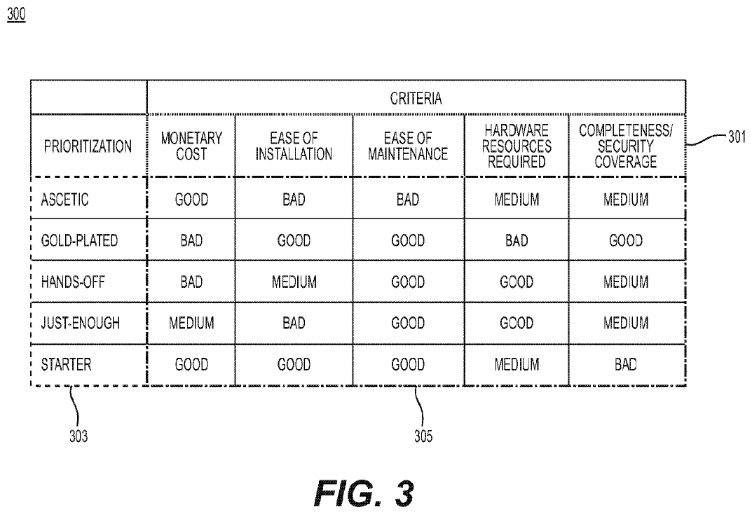

FIG. 3 is an exemplary output 300 of output matrix 215. On one axis, criteria derived from the product data organized by the product analysis tool is provided using predetermined relevant criteria 301. In the exemplary output 300, criteria such as monetary cost, ease of installation, ease of maintenance, hardware resources required, and completeness or security coverage are chosen as predefined criteria. These criteria are weighted and informed by the traditional criteria 203 and additional criteria 205 organized by the product analysis tool 211 that is ultimately provided to the decision engine 213. Customer prioritization, illustrated as prioritizations 303, are predefined criteria that are provided in response to the customer survey data 201 fed into the customer analysis tool 209 and ultimately provided to the decision engine 213. Prioritizations 303 may be provided a column, such as that illustrated in FIG. 3. It will now be clear to one of ordinary skill in the art based on the above the foregoing explanation that different ranking and weighting methods systems may be used to assign values to each of the criteria and prioritization's discussed above. In addition, it will now be apparent to one of ordinary skill in the art that other methods of assigning customer prioritizations may be used without deviating from the embodiments described herein. For example, predetermined types of prioritizations may be determined by analyzing a group of similar customers and their responses to node question-and-answer pairs. After gathering an appropriate number of such node question-and-answer pairs, the operator of the system may predefine prioritizations consistent with the results of those pairs. Alternatively, the system itself may automatically analyze node question-and-answer pairs and define prioritizations based on associations between the question-and-answer pairs and relevant prioritizations.

The relevance of product criteria 301 is mapped against the prioritizations 303 and a rating is assigned to the intersection points of the map. One embodiment of such mapping is the results 305 that are provided in exemplary output 300. There, ratings of “bad”, “medium”, and “good” express the optimization of the fit of the prioritization of the client with respect to the product criteria 301. Although this exemplary rating system is used in the in FIG. 3, it will now be obvious to one of ordinary skill in the art that any appropriate ranking system may be used to express the optimization of the fit. In addition, it will now be obvious to one of ordinary skill in the art that other ranking systems may be used without deviating from the embodiments described herein.

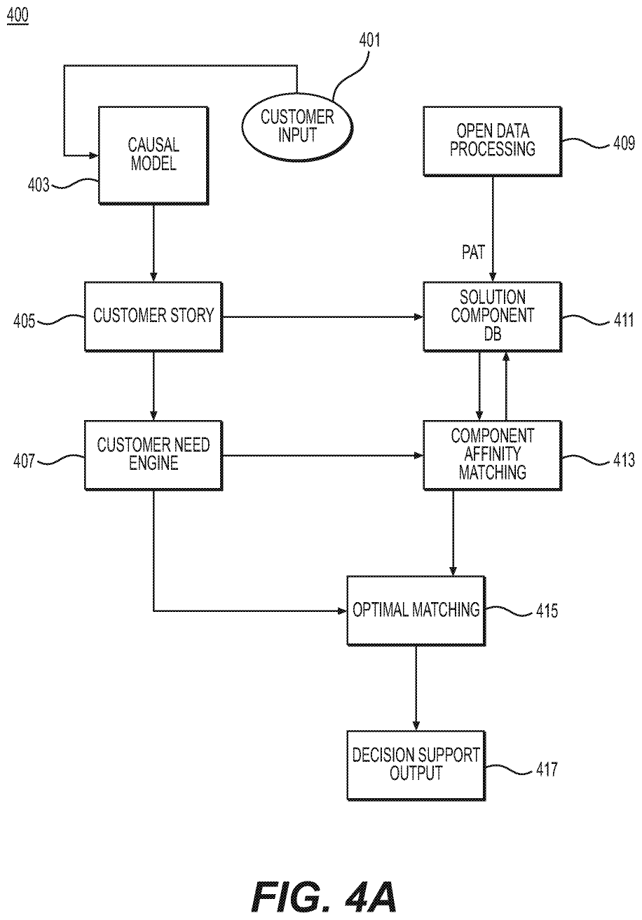

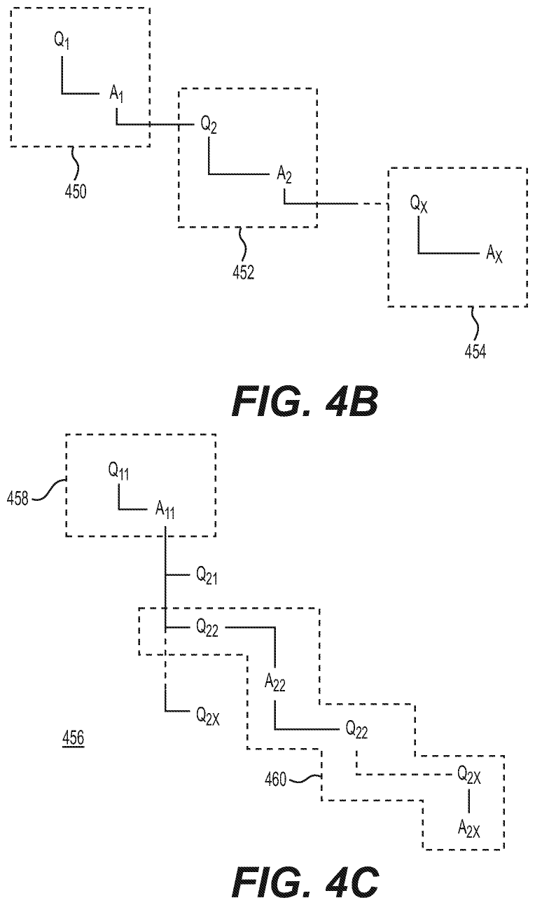

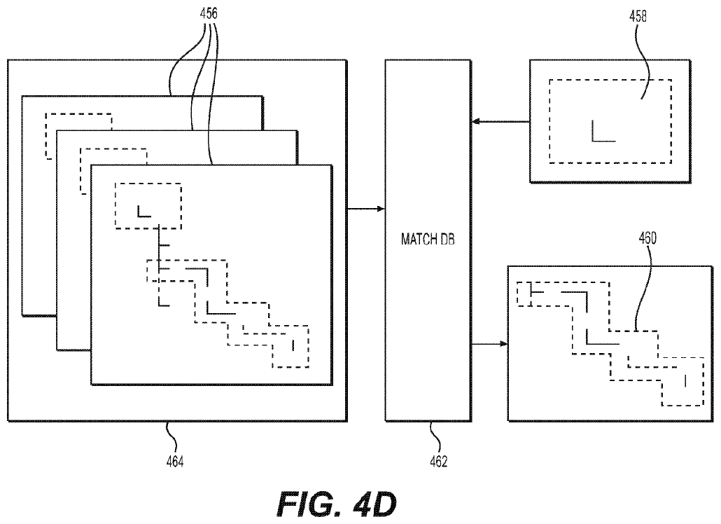

Additional details on how system 200 performs is provided in FIG. 4a. FIG. 4a includes customer input 401 that may be, for example, input derived from customer survey data 201. Customer survey data is then provided to a causal model 403. The causal model 403 is developed into a customer story 405. Customer story 405, for example, may be linked one or more factors representative of categories of prioritizations 303. Customer need engine 407, in turn, may receive the customer story 405 and automatically propagate potentially relevant predetermined prioritization categories, such as those illustrated as prioritization's 303 based on factors derived from the customer story 405. Similarly, open data processing step 409 may be run on the product side using traditional criteria 203 and 205 to build a solution component database 411. The customer need engine and database 411 can feed their respective data component affinity matching unit 413. The predetermined prioritizations provided by a customer need engine 407 and results from the component affinity matching unit 413 may then be fed into an optimal matching unit 415. Optimal matching unit 415 can then prepare a matrix, such as that illustrated as matrix 300, which is then outputting decision support output 417. It will now be clear to one of ordinary skill in the art that matching may be performed by the system in a variety of manner without deviating from the scope of the embodiments described herein.

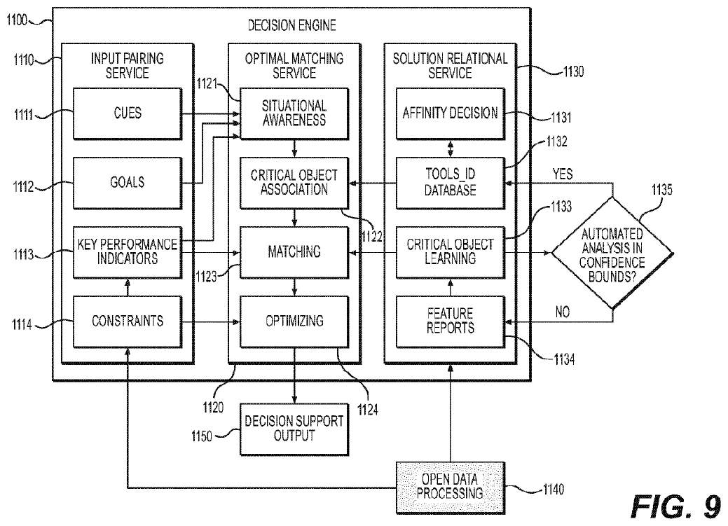

Product and customer need affinity may be determined in different ways. For example, to calculate product affinity a correlation between feature attributes produces a rating for a set of products or objects according to their suitability to fulfill the capabilities within the problem domain as measured by one or more product features matrices (such as the exemplary matrix illustrated in FIG. 14). Each matrix uses one or many data structures describing only individual Products categories, features and origin of said products. Different features matrices will have specific calculations related to use of different weighted averages and confidence level for each feature to inform if positive affinity or a negative affinity exist between products. This affinity correlation provides the understanding that certain products work exceptionally well together, or are incompatible for reasons which extend beyond functional overlap and feature incongruence. All of the calculations may be augmented by a plurality of processed Open Source data processing (further discussed below in FIG. 9) to populate the feature matrix weighing functions. This allows the system to identify products with similar characteristics that support or complement other products to satisfy the overall customer need in an efficient manner.

As discussed above, a causal model may use a sequence of covariants whose potential outcomes individually contribute to a unique causal chain which builds in phases. Each variable associated with the customer criteria discussed above may be implemented as a question node that specifically addresses information required to fulfill a specific criteria set. Said criteria has dependencies on elements such as client type and concerns related to these elements. For example, a question set may be used to determine criteria such as scale of a company. Depending on other knowledge derived from this or prior questions such as a prior node or a parent question, a use case is generated that queues one or more children questions to ensure a context driven total set of questions satisfies the criteria for this specific company. In one such case, scale can be defined by a company's size related to revenue. Depending on the use case, other relevant child questions could be used to increase the fidelity of answer as to the number of computers, the number of employees, and, in some cases, the number of locations. This treatment of a dynamic domain data model allows for a use case development of subsequent question nodes.

Different models to gather input via the user survey responses and to facilitate the formation of questions are illustrated in FIGS. 4b-4d. FIG. 4b represents a question and answer pair model where a predetermined question is asked and a response is provided. For example, a predetermined question related to scale, such as the total employees at a company, may be posed and answered by the user and is illustrated as question and answer pair 450. Next, question and answer pair 452 may be obtained to the system and may relate, for example, to the total number of full time versus part-time employees. The question-and-answer string will continue until all questions are answered, e.g., the final question-and-answer pair 454. As discussed in detail in other portions of this application, the question-and-answer string may be dynamically modified to deviate from the exemplary embodiment illustrated in FIG. 4b, the embodiment illustrated in FIG. 4c. Alternatively, the question-and-answer string may be terminated by comparing the question-and-answer pairs against a threshold that defines when a node associated with the questions-and-answers in a string have provided sufficient information to complete the node. Other exemplary embodiments are now discussed.

FIG. 4c illustrates question-and-answer strings 456 formed using a causal model such as the one described previously. In FIG. 4c, a first question, Q1 is asked. Answer A11 is received forming question-and-answer pair 458. Based on answer All, the system provides either question Q12, Q22, . . . , or Q2X. Each of the questions Q12, Q22, . . . , or Q2X provide different paths to define the specific criteria to be determined and vary based on answer All and result in a question-and-answer pair 458. A question-and-answer pair string results and is illustrated as string 460. As a non-limiting example, if scale is the focus of the questions being posed, and the answer All indicates the customer's organization is small (e.g., less than 10 employees), then questions are focused on those appropriate for smaller organization. For example, Q22 may focus on predetermined questions that are developed for smaller organizations. Based on the answer All, the system will provide question-and-answer pairs that result in string 460 being answered by the user.

Relevant question-and-answer pairs may also be identified by the system by analysis of one or more question-and-answer pairs such as 458 or partial or full strings such as string 460. FIG. 4d provides an exemplary embodiment of one such process. In FIG. 4d, question-and-answer pair 458 is provided to match database 462. Match database 462 compares question-and-answer 458 to stored question-and-answer pairs 464. If question-and-answer pair 458 matches questions and answers pairs 464 stored in match database 462, the question-and-answer pair path 460 may be provided to the user. The system may use identify a relevant string such as 460 based on confidence interval analysis or other statistical criteria to identify the potentially relevant string based on the previous user answers saved as stored question-and-answer pairs 464.

It will now be apparent to one of ordinary skill in the art based on the foregoing discussion, that decision support output 417 may take a variety of forms depending on customer requirements or preferences. In this or another embodiment, the decision support output may be provided via email. In this or another embodiment, the decision support output may be provided online via a web page. In this or another embodiment, decision support output 417 may be provided to a standalone computer or mobile platform. In this or another embodiment, decision support output 417 may be provided in an alternative means, such as a written report, that is provided to the customer in paper form.

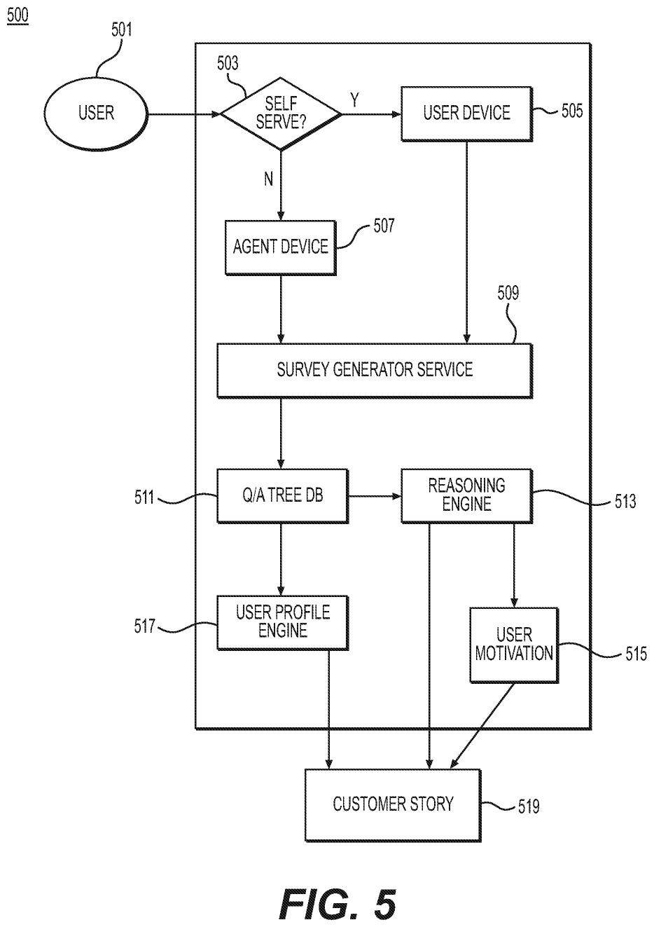

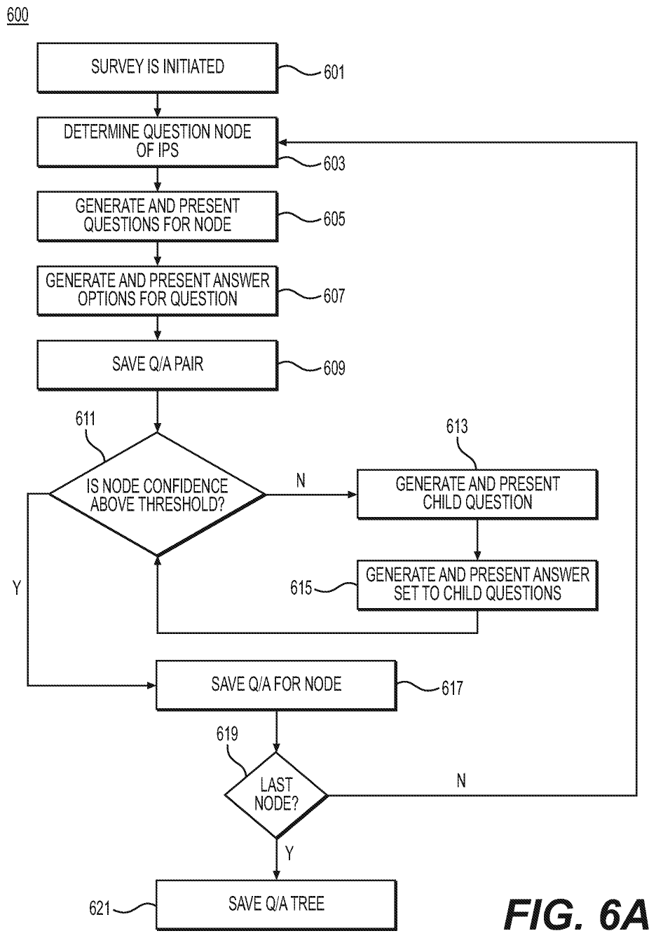

FIG. 5 illustrates subsystem 500. Subsystem 500 includes elements required to generate customer story and may be used with any of the embodiments described herein. As used herein, a customer story may be developed from one or more nodes that identify characteristics of the customer. In addition, the one or more nodes associated with the characteristics of the customer may be blended in order to create portions of the customer story. An exemplary customer story may be represented as a spider graph where characteristics of the customer from the axis of graph. As a non-limiting example, characteristics representative of the different nodes may include industry, scale, cyber intelligence, cyber maturity, and cyber intelligence maturity described herein. The customer story may be expressed as the space within the spider graph applied against such characteristics. Based on this space, appropriate prioritizations may be defined for a specific customer. Alternatively, the resulting space may be mapped to previous customer stories to identify likely customer prioritizations based on earlier evaluated users.

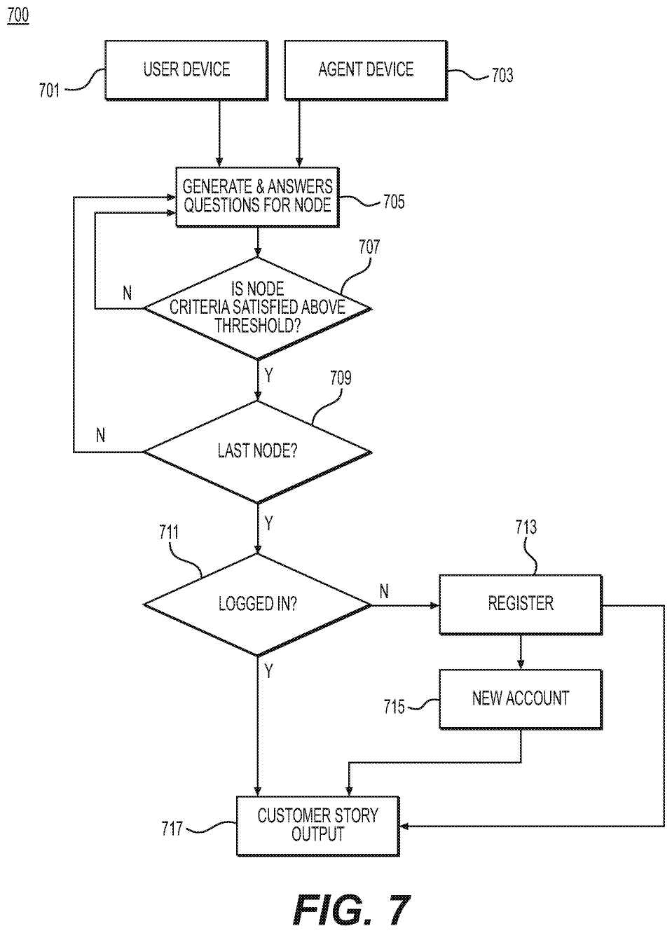

System 500 illustrates in more detail the formation of the customer story. The user 501, e.g., the customer, begins the creation of the customer story process by using a self-driven or “self-serve” approach. Alternatively, the user can select to use an agent device to begin the process. The above choices are represented by step 503 and when a user selects to do the self-serve approach, interfacing between the user device 505 and survey generator service 509 is implemented. If instead the user decides at step 503 to employ the agent device 507, agent device 507 begins interacting with the survey generator service 509. It will now be apparent to one of ordinary skill in the art that user device 505 can be any one of a plurality of devices that allow a user to interface with a computer-based system. It will also now be apparent to one of ordinary skill in the art that the agent device 507 may be in one of a plurality of devices capable of interacting with a computer-based system. The inner workings of the survey generator system 509 is described in more detail below in FIG. 7.

Survey generator service 509 interacts with Q/A database 511 and provides initial input to the database 511. Database 511 includes predetermined questions that are used to derive information consistent with that required by customer survey data 201 discussed above. It will also now be apparent to one of ordinary skill in the art that the various methods of providing questions to a user will include those set forth in FIGS. 4b-4d as described above.

Database 511 will provide questions to survey generator service 509 until sufficient question-and-answer pairs are captured in the system determines that the next node may be addressed. Upon completion of a node, database 511 also provides the results of the question-and-answer pairs associated with reasoning engine 513 and user profile engine 517.

Reasoning engine 513 analyzes the nodes that the system seeks to identify sufficiently to create the customer story. User profile engine 517 compiles completed question-and-answer pairs that it receives from database 511. Both reasoning engine 513 and user profile 517 provide data to complete customer story 519. User motivation unit 515 is also provided the analysis of the nodes completed and reasoning engine 513. User motivation unit 515 analyzes the note analysis provided by reasoning engine 513 to create the customer prioritization categories. These customer prioritization categories may be, for example, prioritizations consistent with prioritizations 303 illustrated in and as discussed with respect to FIG. 3.

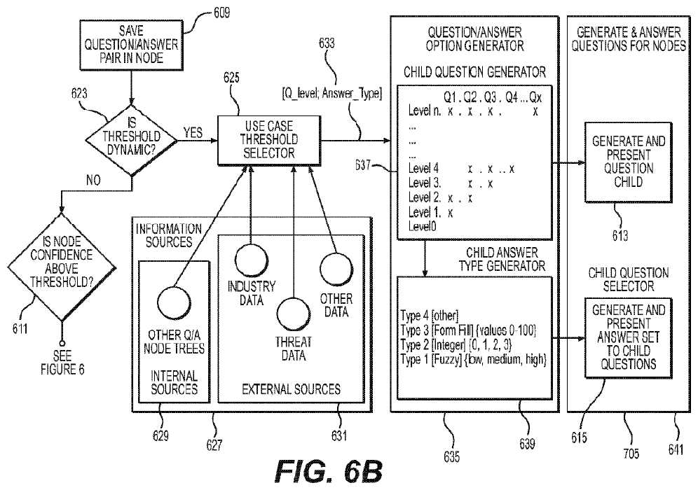

FIG. 6a provides additional details on the operational decision system 200 and in various embodiments of the same described herein. As discussed with respect to FIG. 5, the survey is illustrated in FIG. 6a in step 601. Step 603 sets an initial node to determine questions for feeding the information. As used herein, a node represents a collection of questions related to the customer's motivation and needs. For example, a node may comprise a subset of questions that is included in the larger set of questions present in customer survey data 201. A node may focus on a specific customer motivation, such as the desire for low system maintenance requirements. The node may also focus on others specific customer concerns, such as costs.

Step 605 includes generating and presenting questions for the node determined in step 603. The questions presented in step 605 may be derived from early described Q/A tree database 511.

Step 607 prepares answer options for the questions received from step 605. In this or another embodiment, at least one of the questions provided may be open-ended and allow for the customer to provide a free-form answer. Alternatively, the customer will be presented with a selection of answers in a multiple-choice format. Step 607 may also provide ranked answers to the customer. For example, if the user has already identified additional information about the customer, e.g., require higher privacy settings for the optimize customer product, then at step 607 answers favoring higher privacy requirements can be directed towards the customer. It will now be obvious to one of ordinary skill in the art, that any suitable question and answer format may be designated as part of the generation and presentation of answer options at step 607. Regardless of the answer to the question, at step 609, the question-and-answer pair is saved as part of the answer set to the overall node subset of questions.

The decision point by the system is reached at step 611. Based on the node and the questions and answers received, a node confidence is evaluated. If the node confidence has not exceeded a predetermined threshold, the steps previously performed at step 607 and 609 are repeated at step 613 and step 615, with the exception that step 613 and 615 use a child node question and a child question associated with the child node question. As used herein, the question child node and child question are further subsets of a set of questions used to determine a node. As will be discussed below, child questions may be taken from a previously constructed question set. Alternatively, the system may define new questions based on dynamic information available to the system. As another alternative, the system may alter the form of the question to facilitate customer's input by allowing providing answers of a specific sophistication based on a likely sophistication of the customer. For example, if the user has identified as a system administrator for a large organization during earlier questions, the system may adapt the questions to provide technically more detailed questions appropriate for such an audience. Alternatively, if the user has self-identified as not being in an information technology role at the customer organization and the organization is not large, the system may assume a lower understanding of cyber-security and alter the questions to facilitate answers more easily with less technical detail.

As a nonlimiting example, a node question and child node question may be used to better define the customer's entity size. A node question may seek to identify the size of an entity through a less granular question. For example, “what is the size of your organization?” Answers posed during step 607 may include predetermined answers such as “a. less than 10 employees, b. less than 100 employees, c. less than 1000 employees.” The child question such as that generated step 615 may seek to further probe potential impact of this entity size for the customer. For example, a child question generated in response step 613 could take the form of “how many of your employees are full-time employees?” Predetermined answers to such a question may include “a. all, b. less than 50%, c. less than 25%?” In combination, these exemplary questions and child questions could be used to better define the customer's needs, such as cost considerations that will be driven by the number of licenses required.

Once the node confidence at step 611 exceeds the predetermined threshold the system precedes the steps 617. It will now be obvious to one of ordinary skill in the art that a variety of threshold assessments may be used in conjunction with step 611. At step 617, the question-and-answer pair or pairs, comprise of any node questions and child node questions posed to the customer are saved in the specific node that is the basis for the questions is considered complete. The system then proceeds to step 619 and confirms if all nodes required to complete a customer story have been met. If not, the system returns to step 603, identifies the next required node, and proceeds again through the steps until node confidence above the threshold for the next required node is met. If all the nodes required by the system have been addressed, the system proceeds to step 621, and saves the question-and-answer tree.

FIG. 6a includes node confidence and whether this statistically exceeds a threshold at step 611. FIG. 6b illustrates an alternative embodiment that uses a dynamic threshold instead of the statistical threshold to complete the analysis of a node. As shown in FIG. 6b, after question-and-answer pair is saved at step 609, rather than proceed directly to the threshold analysis at step 611 is shown in FIGS. 6a and 6b, the system can assess whether the threshold is dynamic. If the threshold is dynamic as determined at step 623, the system can proceed to step 625 inactivated case threshold selector.

By using a dynamic threshold to alter the questions and answer gathered by the system, different situations may be addressed. For example, when early responses indicate a complex product need by the client, the dynamic threshold may be triggered. Examples of a dynamic threshold may include, for example, multi-functional product requirements or other more complicated technical requirements are required by the user. As an exemplary example, where an organization has been identified as having specific industry needs, where the organization has employees working in a variety of different offices, and where the organization requires multiple layers of access to data used within the company, the case threshold selector may identify that the level and type of questions required are different than in a simple case where a single product will address the user's needs. As an example, the dynamic threshold may be triggered automatically if an industry that routinely deals with sensitive information is identified by the user in an earlier question-and-answer pair. For example, if the user identifies the company as operating in the health care space or financial sectors, both of which have different but more rigid regulatory requirements than other industries, then the dynamic threshold may be automatically triggers. Other triggers for a dynamic threshold may include multinational business operations, the need for the user to use encryption, or other examples consistent with more complex production solutions are typically required.

If a dynamic threshold is triggered, the case threshold selector 625 gathers information from various sources including those discussed above. For example, the case threshold selector 625 use internal system data source 627. Data source 627 may include other question-and-answer strings including customer question-and-answer strings already answered by the user, similar question-and-answer strings previously answered by other users, or both. In addition, or in the alternative, case threshold selector 625 may utilize external source data 631 such as industry data, threat data and other data.

External source data may be used to create new questions in child question generator 637. For example, where a recent attack in the customer's previously identified industry recently took place, the external source data may include keywords relevant to specific security needs required by the user to respond to such threats. Such keywords may be used to form specific questions to pose to the user to test their understanding of the relevance of such information.

Case threshold selector 625 may set a level and type for questions and answers to be provided by the question-and-answer generator 635. This data definition vector 633 includes a question level and an answer type. In essence, the level and type of questions and answers tune both questions and answers to be more relevant for the user. Level, as used herein, indicates whether or not more detailed or a greater number of questions will be required to address the complexity of optimizing the correct product selection by a customer. As illustrated in FIG. 6b, child question generator 637 may feed up questions of different levels to a user. For example, a level 0 is a low level of complexity and may require only a single or no questions. In contrast, a level 4 is indicative of a high level of complexity and may require a substantial number of questions be posed to the user to address to fully understand the requirements for optimized product matching. Child answer type generator 639 may adjust the type of answer. The type of question, as used herein, refers to the form of the predetermined answer fields that may be provided in response to the questions generated. As an example, if the knowledge related to cyber security by the user is low, a type 1 question that uses a fuzzy classification may be used (where appropriate) to frame the users answer. In any embodiment described herein, the type of the question may be adjusted to the expected response of the user based on the likely user's knowledge. In a specific example as described here, the type of answers available to the user may be calibrated a specific user's knowledge related to cyber security and their experience with the same. Once appropriate level and type question-and-answer pairs are generated, these may be further categorized and analyzed by unit 641 and ultimately provided to step 705 described in more detail below.

External source data 631 may be gathered automatically periodically by the system using, for example, web scrapers and other tools described herein. It will also now be obvious to one of ordinary skill in the art that other methods of automatically gathering, categorizing, and sorting the relevance of data may be used to propagate external data 631. Based on internal source data 629, external source data 631, or a combination of both, case threshold selector 625 will identify a question level and desired answer type that is provided to dynamic question and answer option generator 635.

FIG. 7 describes additional details that may be implemented in conjunction with the system and methods described with respect to FIGS. 5, 6a, and 6b. Using a user device or an agent device, respectively user device 701 and agent device 703, step 705, 707, and 709 may be implemented in a manner consistent with FIG. 6 and elements 601, 603, 605, 607, 609, 611, 613, 615, 617 and 619. Upon reaching step 711, the customer's login status is checked. If the customer is not registered, the system can proceed to step 713 and register the user. If necessary, a new account 715 corresponding to a new user or customer, may be established. Step 717 then saves or updates an existing customer story output. Alternatively, if at step 717 it is determined that the user is a logged in, the system will proceed directly to step 717 to save or update the customer story output.

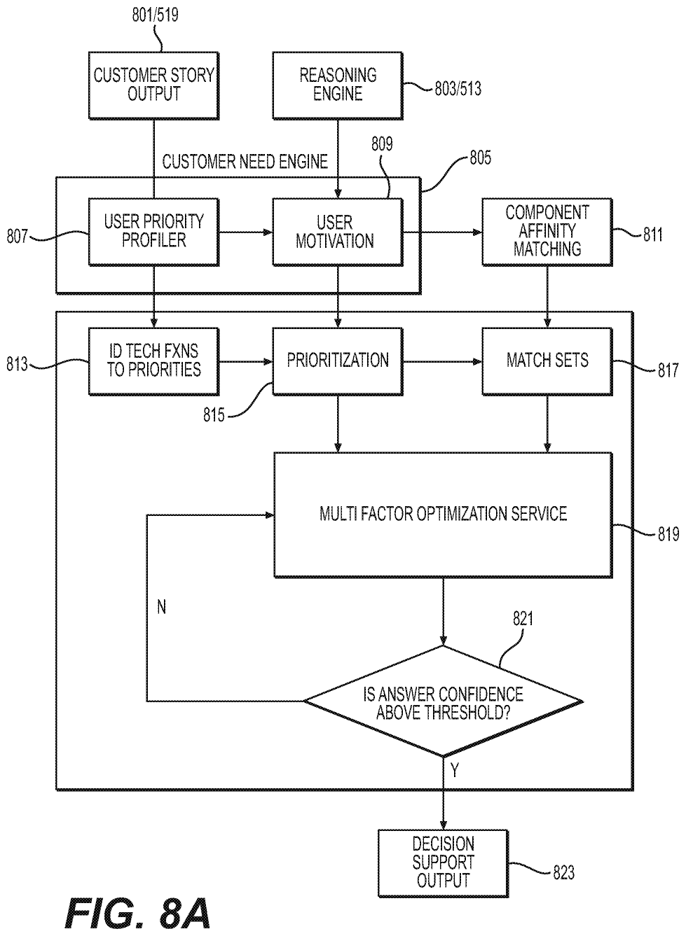

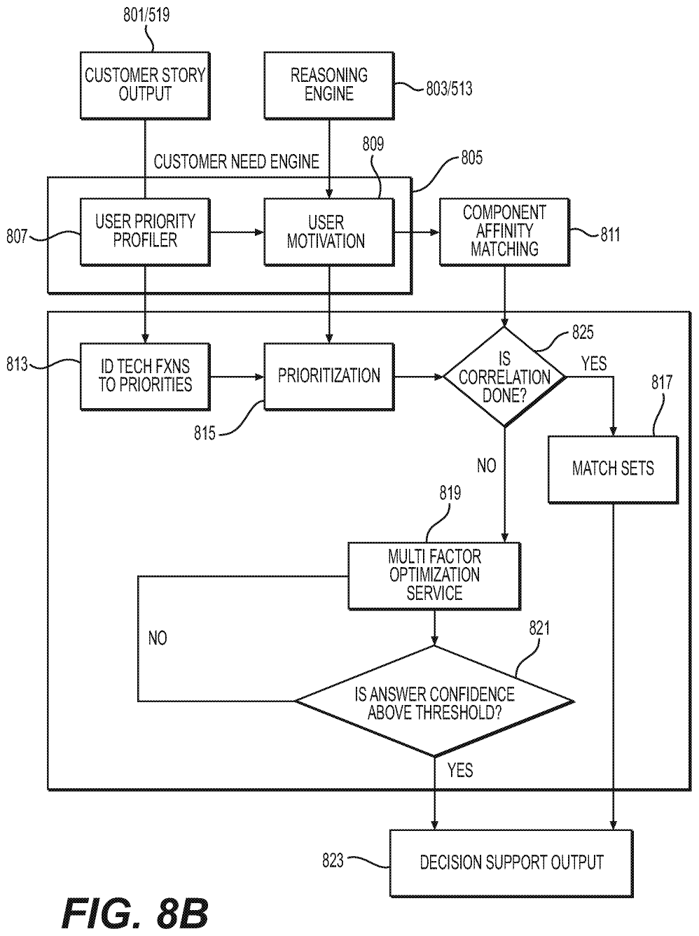

FIG. 8a provides additional detail that further informs the above discussed embodiments in FIGS. 2 -7. Inputs from customer story output 801 and reasoning engine 803, may respectively correspond to customer story 519 and reasoning engine 513, discussed in greater detail with respect to FIG. 5 above. Customer needs engine 805 receives the inputs from customer story output 801 and reasoning engine 803. Customer needs engine 805 then processes those respective inputs to develop user priority profiler 807. User priority profiler 807 takes the customer story output 801 and provides input to user motivation 805 as well as ID tech functions to priorities unit 813. User motivation unit 809 receives the input from the user priority profiler 807, as well as a reasoning engine 803, and provides data to facilitate construction of customer prioritizations, such as those illustrated as prioritizations 303 in FIG. 3, feed into prioritization unit 815. The output of customer needs engine 805 is also fed into component affinity matching unit 811. Component affinity matching unit 811 retains and processes data related to the product matching, such as that as discussed in FIG. 2 with respect to traditional criteria 203 and additional criteria 205 that is processed by the product analysis tool 201. The data from prioritization unit 815 and match set unit 817 may be fed into multifactor optimization service 819.

FIG. 8b illustrates an alternative embodiment of system 800. In FIG. 8b, output from component affinity matching unit 811 is provided directly to step 825. Correlation of the prioritization (output from prioritization unit 815) is considered in combination with output from component affinity matching unit 811. If a matched set is determined to be made by unit 817, then the result is provided directly to the decision support output unit 823. If the correlation is incomplete, the system may direct the combined data set to unit 819 for further processing and assessment against a confidence threshold at step 821. Once the confidence is sufficient, the results are then provided to unit 823.

User motivation unit 809 receives the input from the user priority profiler 807, as well as a reasoning engine 803, and provides data to facilitate construction of customer prioritizations, such as those illustrated as prioritizations 303 in FIG. 3. Processed data by the user motivation unit 809 is fed into prioritization unit 815 which ranks functions related to user priorities. The output of customer needs engine 805 is also fed into component affinity matching unit 811. The data from prioritization unit 815 is compared with results sets from the component affinity matching unit 811 where an initial correlation is assessed. If correlation exists, a match set from unit 817 may then be fed into decision support output 823.

From time to time, the data from prioritization unit 815 and component affinity matching unit 811 result in no clear solution correlation. For example, if component affinity matching unit 811 results in many solution alternatives which are all viable, or prioritization unit 815 does not provide simple correlation to create a matching set 817, then additional processing is required and data may then be fed into the multifactor optimization service 819.

Multifactor optimization service 819 is tasked with producing the combined product and customer input to produce an output such as that illustrated in FIG. 3 as output 300. It does so in an iterative fashion. For example, an initial output is produced by multifactor optimization service 819 and provided to the confidence assessment unit 821. Unit 821 evaluates the resulting output against a predetermined threshold and allows the system to proceed to the decision support output 823, which may be the output 300 as described above. Alternatively, if unit 821 determines that the predetermined threshold based on ranking and weighting methods has not been met, then it returns the proposed output to multifactor optimization service 819 for further processing by combining an additional one or more potentially relevant predetermined prioritization categories derived from the customer need engine 407.

Referring to FIG. 9, a specific embodiment of the Critical Decision Engine (CDE) 1100 includes an Input Paring Service (IPS) 1110 which iteratively interacts with the Optimized Matching Service (OMS) 1120, and a Solution Relational Service (SRS) 1130, consistent with embodiments described above is illustrated. By integrating these 3 modules to deliver multiple factor decision-making, the CDE 100 process divides the decision-making support process iteratively into four tasks; (1) recognizing the situation, which course of action makes sense for the current situation; (2) then evaluating the course of action by (3) matching components to meet goals and (4) providing alternatives to best matches. This system and method uses the adaptive survey questions and answers from the IPS to generate human-readable reviews and analytic data bases that define the Decision Support Output, based on the answers to the questions and the augmented context from Open Data. In this case the system and methods employ a dynamic rules-based analysis engine having a plurality of rules for categorizing, selecting, scoring and ranking matching accuracy for a plurality of sub-choices by segregating data collection into four parts: cues (Ci)1111, goals (Gi)1112, KPIs or key performance indicators(Ki)1113, and constraints(COi)1114.

The cognitive causal model that defines the problem statement the CDE 1100 operates on depends on the Situational Awareness (Si) 1121 to formally denote that an instance would be defined as Si=<Ci, Gi, Ki>, where Ci, Gi, and Ki are collections of predicates, and COi is a set of information referring to pre-defined open data scored KPIs to understand the situation. In this case the use of Open Data Processing 1140 supports a rules-based analysis to provide external context to user-provided information and presents through said user interface choices to aid the user in making a decision, said choices being at least one from the SRS to identify elements for potential course of action.

The SRS 1130 maintains solution data models relevant to the problems the CDE 1100. The SRS may update and enhance the solution definitions based on manual or automated database updates using defined or open data from one or multiple sources such as vendor provided information, structured and unstructured data to refine the models for each solution component. Content used for updates may use human or computer aided sources to define feature reports 1134. These reports will associate key features, topics, and scores for same are herein described as Critical Objects. Critical Object Learning 1133 may provide a human operator and/or automated scoring service training set extracted from open data processing 1140. This content will inform associated queries related to criteria relevant to Tool_ID Database 1132 if the analysis is within confidence bounds 1135 or it will iterate to enhance the description based on said open data scores based on the fuzzy category (e.g., high, medium, low) or other scoring methodology to identify the affinity 1131 of solutions as described by a multiplicity of features. This affinity can be expressed in k-value or other vector value wherein the features can uniformly describe the solution elements as an enhanced solution definition in order to find high affinity based solution sets as described by a singular or multiplicity of Tool_IDs.

The OMS 1120 uses the CDE 1100 problem definition from the cognitive causal model and enhanced solution definitions in the SRS to provide the decision support output 1150. Upon definition of the situational awareness 1121 from the IPS 1110, Critical objects associations 1122 may be selected based on a similarity to, and an accuracy of, each critical objects from existing objects or associated with the new critical objects if no association can be made. COAs are identified and included in any feasible combination, their association is computed based on the SRS analysis. Said analysis focuses on matching 1123 by using a plurality of features that impact calculation of the requested key performance indicators as determined on a meta-model of each of the related solution. An algorithm for making the requested key performance indicator calculation is generated based on metadata retrieved from the meta-models of each of the related features from SRS.

These Critical Objects Association (COA) sets 1122 are compared using a ranking function model that supports iteratively refining and tuning of said model by selecting training data sets which are periodically updated and refined by the results or validation sets that include new events or queries for which the associated documents have been labeled and scored (e.g., scored on a fuzzy or numerical scale).

Matching data is retrieved from instances of a set of business objects matching at least one limiting criteria, and a value is calculated for the requested key performance indicator calculation based on the algorithm and the retrieved transactional data. The OMS optimizes 1124 the matches by augmenting the adaptive surveys from the IPS to allow for other open data to provide weighing functions that are independently created and compared against the Ci, Gi values by analyzing the same for their users. The Optimizing functions in the OMS determines the best possible solution based on all criteria to provide one or more Decision Support Output reports 1150.

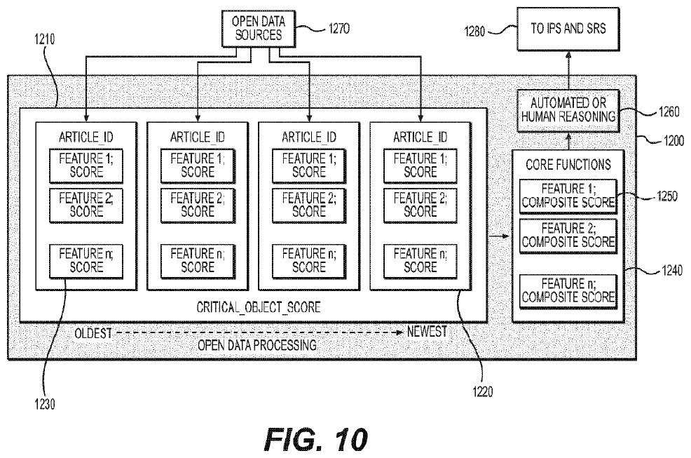

Open data processing, as illustrated in FIG. 10, is used to augment the user input unto the IPS and the SRS description of solutions and tools. Use of one or more open sources of information 1270 addresses the distributed cognition problem by finding content or articles 1220 from these sources (e.g. forums, websites, studies, reports, news articles, amongst other sources) and extracting topics, features, key phrases with one or more feature values 1230 (e.g.,a feature value which may be based on an aggregate or statistical feature value of the associated documents), and/or other characteristics based on the characteristics of documents identified in open data Article. An Article Id is associated with the resulting feature and respective value set. By estimation of relevance and currency a time bracket is established from which critical object scores 1210 are statistically derived by geometric mean or other method across common features for the Article Ids within this time window. In one embodiment, this analysis may involve the determination of a plurality of feature values for each of the articles associated with a given critical object that is then is statistically summarizing or aggregating these values into core function 1240 matrices. Because each Article may have a different number of associated features, it may be appropriate to transform the matrixes having non-uniform dimensions into vectors having a uniform length (e.g.,a length equal to the number of features under evaluation, a length equal to a multiple of the number of features, etc.). As critical objects critical object score are scored the density of features will provide indication of core functions associated to the CDE 1100 problem statement and the associated features and composite score 1250 calculated from all the relevant articles. In this embodiment these aggregate statistics allow automated systems, expert systems, or other related systems 1260 to support context to IPS and SRS 1280.

For example, we may have three articles features are considered, such as feature frequency (ff), document length (dl), page rank(pr), and other measures for defining associated articles matrixes we may generate statistical measures for each of the features and/or aggregate representations of the feature values.

According to one embodiment, the input gathered from the user within the IPS is done by generating a survey with at least one question and answer options for the at least one question. The survey may be transmitted to an electronic device associated with a user. The selection of the at least one answer may be stored in a database.

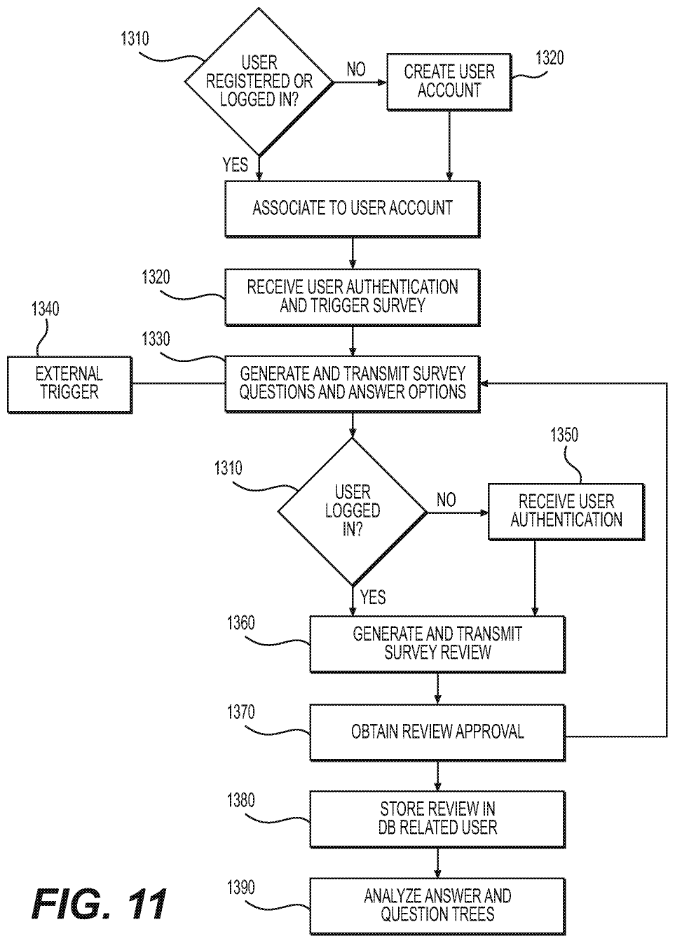

In another embodiment, FIG. 11 illustrates how users which have logged into 1310 an account associated with said user whereby User Authentication can be needed to trigger a survey 1350, 1320. The questions from this survey may be focused on the primary criteria relevant to CDE 1100 problem domain. For example, cues and goals could be related to criteria and rational consumers use when making purchase decisions about a business, such as value, usability, and convenience and/or other related criteria.

In the preferred embodiment a trigger to initiate and generate a survey 1320 may include requests through a standard or mobile website, an email or SMS link to the system(e.g., a URL), a quick response (QR) code representing the link or other triggers 1340. This survey will be transmitted 1330 to collect information in a single session or multiple sessions from one or multiple users related to CDE 1100 cues and goals against problem domain. The survey may accordingly be unique to the problem domain defined by the business and/or the category of the business so that the questions and answer options are suitable and appropriate. For example, if the business is a law firm and, the problem is cyber security then the question and answer options may be related to business risk and data security, as these cues and goals factors tend to be more important to consumers of law firms.

Once the questions have been transmitted and answered in open text form, selection of multiple answers, or other answer options that have been predefined per question a survey review 1360 is presented for approval 1370 and storage in user profile 1380. The question and answer set will be analyzed 1390 to derive the summary of the outputs of the IPS 1110.

From the user provided elementary data derived cues and goals in the IPS 1110 can be considered root problem statements or topics or nodes that may have any number of child nodes that can be the basis for generating future follow-up questions and the answer options for said questions. Each root question node may have child question node that may have possible choices or answer sets with attributes such as type, numerical value, a text value, a sentence value, an analytic value, a statistical value, and/or other attributes.

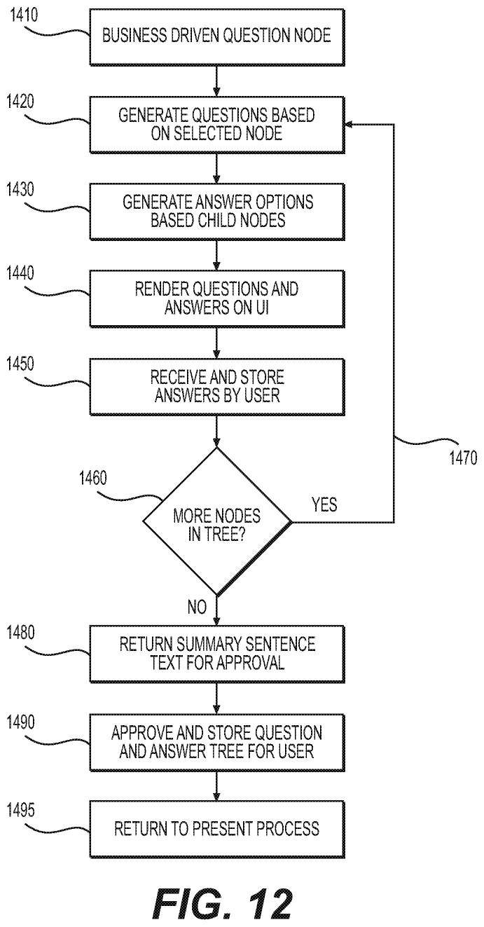

FIG. 12 illustrates a flow diagram with a survey model for the Input Pairing Service. Each survey can start with Business Driven Question node 1410 related to CDE 1100 question and answer are collected to serve as a processor and understand the criteria that will generate questions based on same 1420 and the choice options for said question 1430 for the next survey stage as related to the next root question node and child question node 1430 through single or multiple iterations as needed to refine the information collected related to the CDE problem domain. For example, a user may enter geographic, industry and business size information resulting in a question and answer trees that respectively serve as processor models which may queue a new question root or child node to allow the entity to be presented by electronic means the next most relevant questions and answer options.

A summary of the overall profile 1480 may be provided at any point the data is sufficient that user validation and storage 1490 may provide higher confidence in the resulting decision support output. This output will provide the parent CDE process 1495 question and answer values for OMS 1120 processing. As such a sentences used to describe said summary will use each root and child question and answer tree to generate sentences based on sentence templates which may account for semantic sentence type, narrative type, message tone, and sentiment and/or other values corresponding to the appropriate sentence templates in order to make semantic and syntactic sense.

Upon getting root question node information from answering against the problem domain a new node 1460 may produce future follow-up questions related to a singular or multiplicity of key performance indicators (KPI) which are used to understand confidence of the OMS output. We can derive these KPIs by analyzing constraint information related to the question node and related questions and answer options. Associated with each root question node or child question node is an answer node. The root answer node and each of the child answer nodes may have attributes including a selected answer option value, an initial answer value, a back token value, an intensity value, and/or a free response text answer value. Therein the collection of answers produces an answer tree. The answer tree and its answer nodes may have a relationship with the root question nodes and child question nodes that the survey is based on. In particular, the root answer node and each of the child answer nodes may respectively correspond to a root question node and child question nodes used resulting in the root question tree. In this way, a particular answer node in the answer tree can have access to and retrieve the attributes in the corresponding choice node for purposes of generating sentences of the review, as described below.

In the preferred embodiment a user in search for cyber security help selects an answer option associated with a choice root node related to a criteria of “integration”, the question text value for a future question may include “interoperability” so that the future follow-up question that is generated asks the user to describe the current state of the business, for example. Using the question and answer tree values the IPS may construct sentences in a generated review as to validate the story developed throughout the iterations of the survey. The values can be used to automatically generate human readable prose of a review of the story customized to the entity.

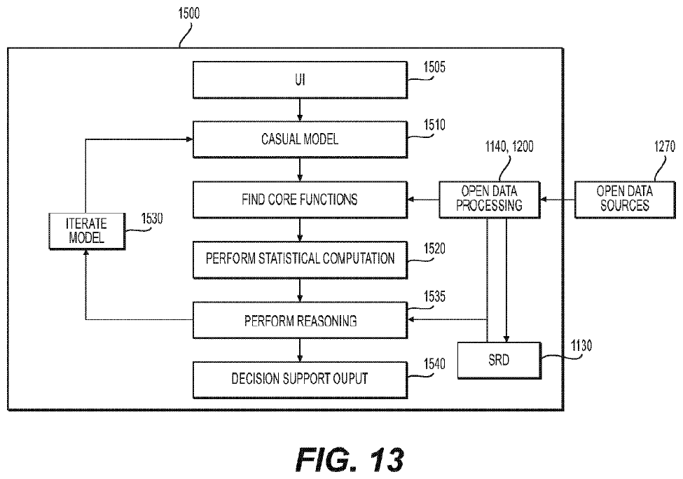

FIG. 13 describes the OMS 1120, 1500 and user journey from the input pairing service 1110 which may be triggered from user provided elementary data or lower-level information collected from the user interface (UI) 1505. Said information is abstracted as user cues 911, goals 912, and Key Performance Indicators 913 of the overall application and defines a preliminary profile which is assigned to a causal model 1510. For example, internally a user may only care about the fuzzy scale rather than the real value of a question. This generates a cue which can be the root of several tree-like information—dependence structures which may define the Core Functions 1240 used to find features such as constraints 914 and best scores defining solutions based on the CDE 900 problem domain. For example, by collecting the customer input 101 from the user the OMS in one embodiment may find one or plurality of functions and related features that are abstracted from low-level information which can support OMS matching function 924.

Additional survey questions 603 are used to define a plurality of goals and key performance indicators (KPIs) to build discriminators such as weighing functions or other statistical parameters for defining core functions for said profile. By comparing this to knowledge collected and scored from open data processing 1140, 1200, we can calculate 1520 the statistical and time relevant score of the derived core functions 1240.

The core functions are then augmented by a plurality of processed Open Data 1370 to provide expert, vender, and open source knowledge scores used to define the plurality of core functions and KPI criteria 913 for every dimension of the solution (i.e. interoperability, cost of ownership, usability, etc). Statistical analysis on the core functions can optionally correspond to a plurality of business process features and at least one limiting criteria (i.e. demographics, complexity of entity, etc.) which can optionally be obtained as a parameter in the IPS.

The core functions are then augmented by a plurality of processed Open Data to provide expert, vender, and open source knowledge scores used to define the plurality of core functions and KPI criteria for every dimension of the solution (i.e. interoperability, cost of ownership, usability, etc). Statistical analysis on the core functions can optionally correspond to a plurality of business process features and at least one limiting criteria (i.e. demographics, complexity of entity, etc.) which can optionally be obtained as a parameter in the IPS.

The output of the Statistical Computation will provide reasoning 1535 justification to determine the level of confidence the matching has. In case feature-matching cannot provide an adequate situation resolution due to lack of information or experience, story building is adopted to construct a story (i.e., a causal sequence of events) that can link the pieces of observed and available information into a coherent feature set. This Reasoning step allows for the story to provide an iterate model 1530, e.g., a feedback opportunity for the model and Criteria for the confidence of the OMS Decision Support Output 1150. Output from Open Source Processing 1200 can augment this Reasoning 1535 step as it can collect from Open Data changes in related external limiting criteria not provided by user in the IPS (i.e. changes in regulatory environment, changes to threat profit, etc.).

This summary of the CDE 1100 is provided to introduce a selection of concepts in a simplified form that are further described herein. This disclosure intends to explain the methods and exemplify various embodiments in accordance with technology rather than limit the intended fair scope and spirit of the invention described herein. The foregoing description is not intended to be exhaustive or to limit the precise forms disclosed herein. Variations to the electronic delivery, methods, and decision support processes are possible in light of the above. The embodiments where chosen as illustrative and principally describing the technology, methods for application of functions, and providing examples for how various modifications are suited to the particular use.

FIG. 14 includes an exemplary feature to product matrix 1400. In particular, specific features are identified for all products in a specific product space and if an specific product, e.g., product 1 includes that feature, it is stored in the matrix. An exemplary match is indicated as match 1410. It will now be apparent to one of ordinary skill in the art that product features may be defined based on the traditional or additional criteria discussed above.

While the invention has been described with respect to a limited number of embodiments, those skilled in the art, having benefit of this disclosure, will appreciate that other embodiments can be devised without departing from the scope of the invention as disclosed herein. Accordingly, the scope of the invention should be limited only by the attached claims.

1. A method for optimizing a match between a customer prioritization and one or more products, the method including:
defining criteria that characterizes the one or more products including: capturing traditional criteria related to the one or more products, and capturing additional criteria related to the one or more products;
establishing customer prioritizations based on at least two question-and-answer pairs gathered from the customer and determining the prioritization by:
generating at least one question related to the customer's organization, capturing the answer to the at least one question to form a first question-and-answer pair,
comparing the first question-and-answer pair to stored question-and-answer pairs, the stored question-and-answer pairs being associated with customer profiles,
selecting a specific customer profile having the highest affinity with the first question-and-answer pair,
choosing a second question based on the specific customer profile, providing the second question to the customer,
capturing the second answer and forming a second question-and-answer pair, and
evaluating at least the first question-and-answer pair and second-and-answer pair to establish at least one customer prioritization based on the evaluation;
mapping the criteria against at least one customer prioritization; and outputting at least one matched product based on the mapped criteria and at least one customer prioritization.

2. The method according to claim 1, wherein
prior to outputting the matched product based on the mapped criteria and at least one customer prioritization, the relevance of the at least one customer prioritization is compared to a predetermined threshold, and if the relevance of the prioritization of the at least one customer prioritization does not exceed the predetermined threshold, at least one additional question is provided by the system to the customer and the customer's answer is captured to form an additional question-and-answer pair, and wherein the evaluating of the at least first question-and-answer pair, the at least second-and-answer pair, and the additional question-and-answer pair are evaluated to establish a new at least one customer prioritization based on the evaluation, and
the relevance of the new at least one customer prioritization is compared against the predetermined threshold.

3. The method according to claim 2, wherein the predetermined threshold is static.

4. The method according to claim 2, wherein the predetermined threshold is dynamic.

5. The method according to claim 4, wherein when the dynamic threshold is dynamic, the method further includes:
generating at least one child question, the child question being determined by a level of complexity associated with the customer's desired solution, and
generating at least one predefined answer based on an identified characteristic of the customer, wherein the type of answer is determined by the identified characteristic of the customer.

6. A method of improving customer survey responses, the method including:
generating at least one question related to a customer organization; capturing the answer to the at least one question to form a question-and-answer pair;
comparing the question-and-answer pair to stored question-and-answer pairs, the stored question-and-answer pairs being associated with a plurality of specific customer profiles;
identifying a specific customer profile from the plurality of specific customer profiles based on the comparison; and
choosing a second question based on the specific customer profile.

7. The method according to claim 6, wherein a node associated is associated with the question-and-answer pair, and further wherein:
providing the second question to the customer,
capturing an answer to the second question and forming a second question-and-answer pair,
wherein after the second question-and-answer pair is obtained, determining if the node is satisfied based on the receipt of the second question-and-answer pair, and
posing a third question if the node is not satisfied.

8. The method according to claim 7, wherein the node is determined satisfied if it is determined that a predetermined threshold is exceeded.

9. The method according to claim 7, wherein the threshold is dynamic and the second question-and-answer pair include a second question and a second answer that are provided based on the relevance of a threat to the customer and the level of sophistication of the customer.

10. A method of optimizing product selection by a customer, the method comprising: capturing traditional criteria associated with the product;
capturing additional criteria associate with the product;
forming a matrix including product characteristics associated with the traditional and additional criteria; and
processing the matrix based on at least one characteristic identified by the customer as relevant.

11. The method of claim 10, wherein the traditional criteria is obtained from the product vendor.

12. The method of claim 10, wherein the additional criteria is automatically captured.

13. The method of claim 12, further comprising:
weighting the additional criteria based on the source where the additional criteria is captured from; and
increasing the weighting of the additional criteria when the source is identified as reputable.

14. The method of claim 13, further comprising:
checking the version of the product, and automatically resetting the weighting factor when the product as released in less than a predetermined time.

15. A computer readable medium containing program instructions for causing a computer to perform the method of claim 1.

16. A computer system capable of executing the method of claim 1.

17. A computer readable medium containing program instructions for causing a computer to perform the method of claim 6.

18. A computer readable medium containing program instructions for causing a computer to perform the method of claim 10.

19. A computer system capable of executing the method of claim 6.

20. A computer system capable of executing the method of claim 10.
